(19) United States
(12) Patent Application Publication
(10) Pub. No.: US 2008/0026101 A1
(43) Pub. Date: Jan. 31, 2008

(54) Food products

(76) Inventors: Gary Nickel, Edina, MN (US); Andre Roy, Cambridge (CA)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/818,509

(22) Filed: Jun. 14, 2007

Related U.S. Application Data
(60) Provisional application No. 60/813,686, filed on Jun. 15, 2006.

(51) Int. Cl. A23L 1/105

(52) U.S. Cl. 426/52; 426/549

(57) ABSTRACT

Methods of producing a food product for mammals from the soluble by-product fraction of ethanol production are provided. One method comprises the step of incubating the treated soluble by-product fraction with an enzyme mixture capable of digesting complex polysaccharides to yield a food product having a fermentable sugar content of at least about 10% of the total carbohydrate content of the food product. Another method comprises the steps of incubating the unconcentrated soluble by-product fraction with an enzyme mixture capable of digesting complex carbohydrates followed by removal of at least a portion of the fatty acids from the digested material to render a food product having a fatty acid content of less than about 10% dry weight.

### FIELD OF THE INVENTION

The present invention relates to novel food products for use in mammals. In particular, the invention relates to a novel food product prepared from by-products of ethanol production for use as a stand-alone food product or as a supplement in food. The invention also relates to methods of preparing such food products.

### BACKGROUND OF THE INVENTION

Veal feeding has evolved historically as an integral part of the dairy industry. In order for dairy cows to produce milk they must bear calves to stimulate that milk production. Calves are important by-products of that cycle. A first use for calves is as replacement for the cow herd. Many female calves are used for this application. Since approximately ½ of the births are male calves this leaves a surplus of calves for alternate use. Historically adult bulls have produced inferior meat and so a veal calf industry developed to feed calves to an intermediate age to produce premium young meat. More recently these surplus calves have been fed to finished weights.

In all cases newborn calves present a special challenge to animal nutritionists. Newborn calves are pre-ruminant and naturally feed on their mothers' milk until they mature enough to feed on forage. This represents an economic hardship as there is a need to get the mother cows back into commercial milk production as soon as possible. Suitable replacers for mothers milk are therefore normally used to feed the calves early in their lives to wean them from their mothers.

These calf milk replacers require sophisticated blending of ingredients to mimic cows milk. In addition, the ingredients must represent a cost saving over having the mothers continue to feed the calves. Raw material sourcing and selection are an important and ongoing challenge for commercial calf milk replacer manufacturers.

These challenges are also important to milk replacers for other animals such as swine and sheep in the livestock industry. For example, swine milk replacers are important in allowing sows to re-enter the breeding cycle as soon as possible. Milk replacers can also be used for feeding a wide variety of specialty animals including zoo animals as well as dogs and cats in situations where early weaning is necessary or desirable.

Currently, milk replacer manufacturers use a wide variety of raw materials. Many of these raw materials are by-products of the dairy industry. Whey proteins have long been a favored material. Recent technological developments relating to the processing of whey have resulted in increased competition for these by-products. As manufacturers have found new ways of fractionating whey they have introduced new specialized products that have found favor with consumers. The result is increased economic return and higher prices. These developments increase costs of ingredients and animal milk replacer manufacturers consequently continuously search for new sources of economical ingredient by-products.

One such opportunity is represented by the burgeoning ethanol industry. Most of the U.S. ethanol industry uses corn as a source of starch for the fermentation process. Enzymes are used to break the starch down to fermentable sugars and yeast colonies (Saccharomyces cerevisiae) and then convert the sugars to alcohol and carbon dioxide. In so doing, the yeast reproduces itself resulting in a significant quantity of yeast material at the end of the process. Approximately ⅓ of the corn input comes off as alcohol, ⅓ as distillers by-products and ⅓ as carbon dioxide. The following is a typical mass flow description of an ethanol plant: 2.7 gallons ethanol, 18 lbs Dried Distiller's Grains with Solubles and 18 lb Carbon Dioxide. FIG. 1 is a flow diagram illustrating the process of dry grinding process of ethanol production from corn. An alternative, dry milling, ethanol process, generally depicted in FIG. 2, involves the use of dry corn milling designed to sequentially remove corn bran and corn germ in the dry form prior to fermentation. In this case, the remaining corn starch may or may not be cooked prior to digestion and fermentation. Stillage by-products from this method is characterized as having less soluble corn protein and less free corn oil. It has instead a higher ratio of yeast-derived nutrients.

Saccharomyces cerevisiae yeast cannot efficiently convert the complex carbohydrates such as cellulose and protein into alcohol so these components are produced as a by-product and are sold into the feed industry. Included in these feed by-products are the spent yeast cells themselves as well as the various protein fractions.

The feed by-products are a combination of 2 streams. The insoluble fraction includes the fibers and insoluble proteins form the “distillers grains” and are separated by centrifuge from the solubles to prepare them for drying. The solubles consist of the soluble corn proteins, corn oil and yeast fat, soluble non-fermentable sugars as well as the spent yeast bodies. Approximately ½ of the protein in these “corn distillers solubles” comes from the yeast bodies and the remainder from the soluble corn proteins. Soluble minerals and vitamins are also channeled to the soluble flow.

Normally, ethanol producers concentrate these solubles from their usual 4%-6% solids level up to 30% solids in evaporators before recombining them with the wet “distillers grains” for subsequent co-drying. The concentrated solubles contribute protein, fat and energy to the finished product.

The recent growth and the projected future growth of the ethanol industry combined with the significant proportion of output as feed quality material has placed a significant pressure on traditional farming/feeding relationships. Recent estimates have suggested that millions of additional tons of various forms of these ethanol industry feed by-products will continue to make their way into the feed industry. This increasing supply pressure is expected to create some price ceilings and provide price stability.

Many of these components present special challenges to formulators of milk replacers. Ruminants and mature non-ruminants have been shown to thrive on this soluble fraction (CDS) but immature non- and pre-ruminants are unable to take full advantage of some of the nutrients. As a result the obvious attractiveness of the economics of the CDS raw material is not available to manufacturers of milk replacers.

Some of the problem components are the yeast bodies themselves. Yeasts bodies are primarily made up of oligosaccharides, glycosaccharides, fats and minor components such as vitamins. The cell structure is resilient and allows the living yeast to survive in hostile environments. It is made up of an outer mantel of linked mannose, peptide, glucans. This combination presents special problems for use of this CDS material as a milk replacer. Firstly, young animals lack the necessary enzymes to break up this hardy structure. They also lack the necessary digestive system to assimilate the resulting breakdown products such as mannose and glucans. Spent yeasts such as brewers yeast have long been used by animal and pet food manufacturers but these cases the yeasts tend to have been subject to autolysis, a process whereby the yeast is allowed to naturally degrade itself after the feed stock has been used. This is facilitated by naturally occurring enzymes in the yeast. The interior of the yeast body is faced with beta-glucans, the mannose component of which being the outward facing saccharide. The resident beta-glucanase enzyme hydrolyses the interior lining which facilitates the further degradation of the remaining yeast shell.

In the case of CDS, the yeast is typically thermally inactivated by the high temperatures of the distillation process. This thermal treatment also inactivates the resident yeast enzymes thereby preventing autolysis. As a result, the yeast bodies and their hard shells remain intact. This results in a hard to digest fraction for immature animals. Several studies have reported limited success with feeding this material to immature animals. Other studies have shown that the mannose and glucans are partially or totally indigestible by veal calves. CDS also contains a significant fat component and, while fats generally are desirable in high efficiency animal feeds, the fatty acid profile of CDS is somewhat undesirable. Approximately 50% of the fat is made up of omega 6, linoleic acid. This fatty acid is one of the essential fatty acids for humans in that humans cannot manufacture it themselves. They rely on external sources. For some animals, however, linoleic acid may result in soft fat and it has been reported that too much linoleic acid has a toxic effect on young veal calves. Furthermore, the unsaturated fatty acids that are characteristic of the corn oil in corn distillers solubles are vulnerable to oxidative rancidity. This rancidity can significantly negatively affect the palatability of the end feed material. Notably the presence of yeast bodies, which are a source of the disaccharide carbohydrate trehalose, provides a protective effect. Studies have shown that the presence of trehalose significantly suppressed the degradation of fatty acid particularly linoleic acids. This could account for the unusual stability of the fat flavors in the reacted product.

Given the foregoing, it would be desirable to capitalize on the availability and cost savings of ethanol by-products by developing useful products therefrom.

### SUMMARY OF THE INVENTION

Methods have now been developed to prepare novel food products from the soluble by-product fraction of ethanol production. The food products are appropriate for use in both mature and immature infant mammals.

In one aspect of the present invention, there a method of producing a food product from the soluble by-product fraction of ethanol production comprising the step of incubating the treated soluble by-product fraction with an enzyme mixture capable of digesting complex polysaccharides to yield a food product having a fermentable sugar content of at least about 10% of the total carbohydrate content of the food product.

In another aspect of the invention, a novel food product is provided comprising an enzyme-treated soluble by-product fraction of ethanol production, wherein said food product comprises a fermentable sugar content of at least about 10% of the total carbohydrate content of the food product.

In another aspect of the invention, a method of producing a food product from the soluble by-product fraction of ethanol production is provided comprising the steps of:

1) incubating the soluble by-product fraction with an enzyme mixture capable of digesting complex polysaccharides; and

2) removing at least a portion of the fatty acids from the enzyme digested material to render a food product having a fatty acid content of less than about 10% by dry weight.

In yet another aspect of the invention, a food product comprising an enzyme-treated soluble by-product fraction of ethanol production in which the fatty acid content is less than about 10% by dry weight.

These and other aspects of the invention will become apparent by reference to the drawings in which:

### BRIEF DESCRIPTION OF THE DRAWING

FIG. 1 is a flow diagram illustrating the process by which ethanol is produced from corn; and

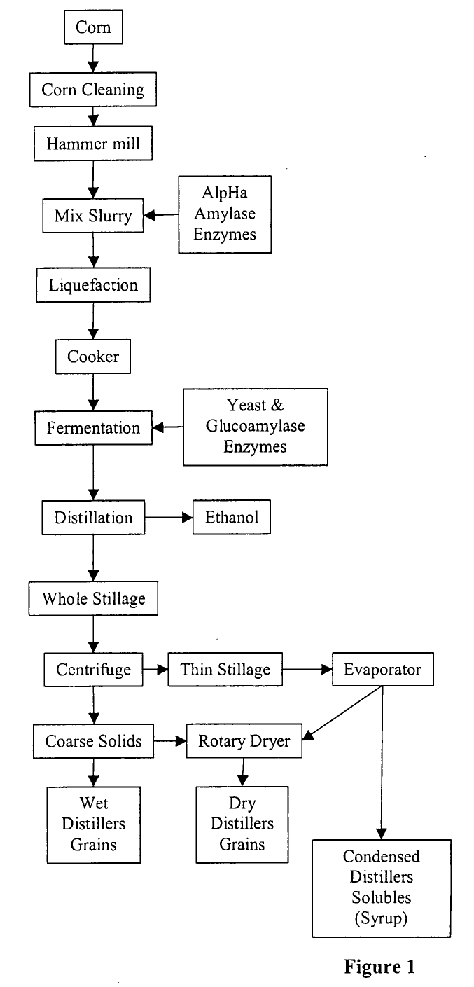

FIG. 2 is a flow diagram illustrating an alternate, dry milling process by which ethanol is produced from corn by separating germ from fermentation feed product without a cooking stage.

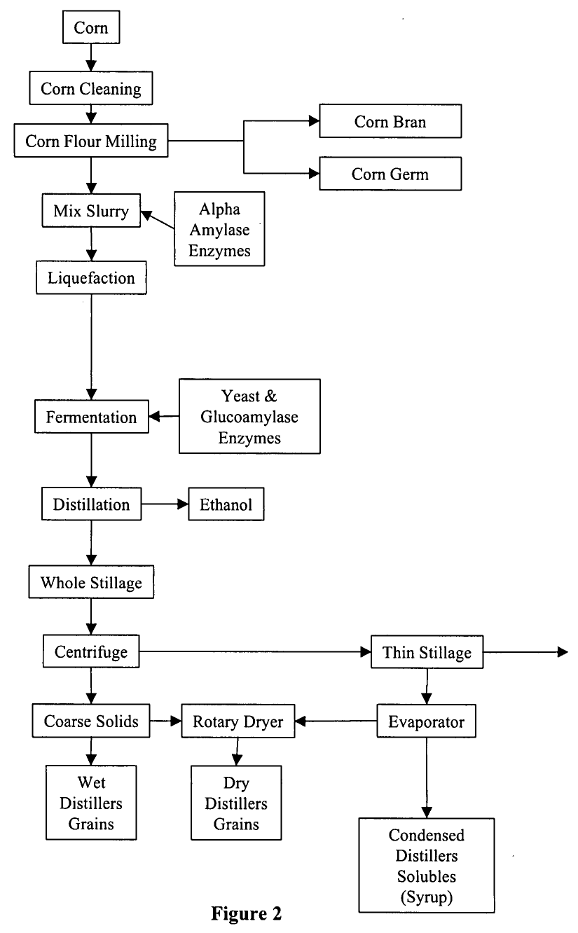

### DETAILED DESCRIPTION OF THE INVENTION

A method of producing a food product for mammals from the soluble by-product fraction of ethanol production is provided. The method comprises the step of incubating the soluble by-product fraction with an enzyme mixture under conditions suitable to digest complex polysaccharides to yield a food product comprising a fermentable sugar content of at least about 10% of the total carbohydrate content of the product.

The term “food product” refers to an edible product for mammals that may be used either alone or in conjunction with other foods as a supplement. The food product is suitable for consumption by human's; livestock such as cattle, horses, pigs, goats and sheep; pets such as cats and dogs; specialty animals such as zoo animals; and wild animals. The food product is suitable for both mature and infant mammals, and can be used as a milk replacer in the case of infant mammals.

As used herein, the term “soluble by-product fraction” of ethanol production is herein meant to refer to the soluble by-products and thin stillage of ethanol production from grains such as corn/maize, sorghum, triticale, wheat, rye, barley and oats. Soluble by-products include, but are not necessarily limited to, soluble proteins, soluble non-fermentable polysaccharides, corn oil, yeast fats, spent yeast bodies including yeast cell wall and yeast cell contents (yeast extracts), minerals such as calcium, phosphorus, sodium, potassium, magnesium, sulfur, copper, iron, manganese, zinc, and vitamins including thiamine, barium, riboflavin, niacin, pantothenic acid, biotin, pyridoxine hydrochloride, folic acid and vitamin B12. It will be understood, thus, by one of skill in the art that the soluble by-product fraction may contain low density insoluble components such as spent yeast body components. Different methods of processing a selected grain(s) for ethanol production currently exist and improvements of these methods are underway. For example, one process includes the use of grinding, steam and enzymes; another uses enzymes alone; and yet another uses soaking and enzymes, each being followed by fermentation to yield ethanol and its by-products. For the purposes of the present invention, the soluble by-product of any method of ethanol production is encompassed.

The term “fermentable sugars” is meant to encompass sugars that can be utilized by a microbe such as yeast or bacteria. Examples of fermentable sugars include glucose, dextrose, sucrose, fructose, maltose and maltotriose. With respect to the present food product, the fermentable sugar content may comprise one fermentable sugar, but will generally comprise a mixture of more than one fermentable sugar.

In one step of the present method, an enzyme mixture is added to the soluble by-product fraction which is suitable to digest at least some of the complex polysaccharides therein, including glucans such as beta-glucans, cellulose, hemicellulose, non-fermentable sugars such as verbascose, raffinose and stachiose, aribinoxylans, pectins, mannans, dextrans and peptidoglycans, and converting these, at least partially, into fermentable or assimilable sugars. The enzyme mixture may include, at least one, and preferably at least two or more enzymes capable of converting complex polysaccharides into fermentable sugars, for example, cellulase, galactosidase, hemmicellulase, mannase, xylonase and beta-glucanase, endo-1,4-β-xylanase, a-arabinofuranosidase, β-xylosidase, feruloyl esterase, endo-1,5 a-arabinanase, endo-1,3(4)-β-glucanase, β-1,3-glucanase laminarinase, endo-1,4-β-glucanase, cellobiohydrolase, β-glucosidase, pectinase, polygalacturonase, pectin esterase, endo-1,4 β-mannanase and β-mannosidase.

Prior to the addition of the enzyme mixture, the soluble by-product fraction may be treated with at least one anti-oxidant in order to prevent the undesirable oxidation of components of the soluble fraction. Oxidation of, for example, fatty acids, can result in rancidity. Examples of suitable antioxidants for addition to the soluble fraction to prevent, or at least minimize, oxidation include carbon dioxide or nitrogen gas, and chemical antioxidants such as, but not limited to, butylated hydroxyanisole (BHA), butylated hydroxytoluene (BHT)), sequestering agents such as ethylenediaminetetraacetate (EDTA), and tocopherols. As one of skill in the art will appreciate, alternative or additional precautions may be taken to minimize oxidation from occurring. The method may, for example, be conducted in a sealed or covered reaction chamber.

The enzyme digestion is preferably conducted under conditions which optimize the conversion of complex polysaccharide to fermentable sugars. The pH of the reaction mixture is adjusted, if required, to a pH suitable for the enzyme digestion to occur, preferably to a pH at which the enzyme digestion will optimally occur. As will be appreciated by one of skill in the art, this may vary with the enzyme content of the mixture. Generally, a pH greater than 4.0 is desired to conduct complex polysaccharide digestion, approximately in the range of 4.2 to 4.8, and preferably in the range of 4.4 to 4.6 to provide the optimal pH for cellulase, betaglucanase, xylanase and mannase activity, while beta glucanases such as EDC beta-glucanase are optimal at about pH 6.0. Likewise, the temperature of the reaction mixture is adjusted to a temperature that encourages activity of the polysaccharide-digesting enzymes, generally at a temperature of greater than about 30° C. and preferably at a temperature of between about 40° and 60° C. In this regard, a temperature of greater than 45° C. desirably inactivates any yeast in the mixture carried over from the ethanol process. Temperatures of 60° C. or more, however, may inactivate some of the enzymes. The enzyme digestion is conducted for a period of time necessary to result in sufficient digestion of the complex polysaccharides in the mixture, for example a reaction period of from about 20 to about 180 minutes, and preferably up to about 150 minutes.

Again, the reaction time may vary with the targeted end product. For example, a longer reaction time may be required to yield an end product having a high fermentable sugar content, while a shorter reaction time is required if an end product having a relatively low fermentable sugar content is desired.

To accelerate the breakdown/digestion of complex polysaccharides, addition of the enzyme mixture to the soluble by-product fraction may optionally be accompanied with a mechanical step to augment the enzymatic digestion or breakdown of some of the complex polysaccharide material, such as the cell wall of the yeast bodies. Examples of methods that may be employed to augment complex polysaccharide digestion include, but are not limited to, high shear mixing, high temperature steam injection and high frequency ultrasonic mixing.

As one of skill in the art will appreciate, the present method of producing a food product from the soluble by-product fraction of ethanol production may include additional steps to provide an enhanced food product. In one embodiment of the invention, at least one protease is added to the mixture, either following or concurrent with the complex polysaccharide digestion. Protease is added to the mixture to decrease bitterness, adjust flavour and to increase the digestibility of the food product. It has been found that digestion of existing proteins and exposed amino acid ends by protease action may result in a more desirable flavor profile and may also increase digestibility of the product. The adjustments made to the food product will, of course, vary with the protease(s) added. Both exoproteases and endoproteases may be used to alter the resulting food product. An example of a suitable combination of exoprotease and endoprotease is Flavourzyme®, an enzyme product of Novo Nordisk derived from Aspergillus oryzue. Additional endoproteases may also be incorporated to further degrade the proteins and liberate additional flavor producing amino acids. Such enzymes include fungal and bacterial proteases as well as botanical proteases. Some examples include, but are not limited to, Alcalase, produced from Bacillus lichenformis; Neutrase, produced from Bacillus amyloliquefaciens; Protamex from Bacillus; papain, bromelain, pancreatin, aspartic protease, a metalloprotease and trypsin/chymotrypsin. As set out above, this optional step is conducted under conditions suitable to catalyze the desired protease activity. In one embodiment, the protease digestion is conducted at a pH in the range of about 5.6 to 6.4, for a period of about 10 to 200 minutes at a reaction temperature of greater than 30°, but less than 60° C. A preferred reaction temperature is between about 45° and 55° C. Proteases such as Flavourzyme exhibit optimal activity at about pH 6.0

In another embodiment, pentoses, hexoses and enzyme-reacted sugars, i.e. sugars resulting from a former enzyme digestion step such as xylose and mannose, are additionally digested to provide food products with varied sugar contents. Altering the sugar content of the food product renders a product that may be more desirable for consumption by certain groups of mammals. For example, a food product with a low mannose content provides a food product that is more digestible and thus particularly suitable for infant mammals, while a food product that has a high mannose content is beneficial in food for swine as it helps to prevent intestinal infection. Thus, in an additional step, a ferment containing active yeasts, for example, Saccharmyces sp., such as Saccharmyces cerivisea and Saccharmyces uvarum and Candida shehatae, may be added to the reaction mixture in an amount sufficient to digest a desired portion of the pentose/hexose content thereof. Alternatively, a smaller amount of pure enzyme suitable to digest pentoses/hexoses may be added, for example, xylanase and mannanase. This pentose/hexose digestion is conducted under conditions of pH and temperature which permit suitable enzyme activity, and preferably under conditions which allow optimal activity, as one of skill in the art will appreciate. Conditions, such as reaction time, will also vary with the desired end product.

In another embodiment, the further step of converting linoleic acid (LA) to conjugated linoleic acid (CLA) is conducted. Linoleic acids in large quantities may be toxic to young mammals. Also, excess linoleic acid in the diet of livestock may have an undesirable effect on the meat therefrom. Additionally, CLA has significant health benefits for mammals, and can be passed onto humans who consume meat coming from livestock having CLA in their diet. The conversion of LA to CLA can be catalyzed by the addition of at least one of a propionibacterium such as or propionibacterium freudenreichii shermaneii. and Lactobacillus casei, Lactobacillus acidpHilus and Lactobacillus rhamnosus. Modification of the lipid components result from the native esterase and lipase activities of these bacteria.

The nutritional aspect of the present food product may also be enhanced by the addition of mineral-containing compounds such as calcium hydroxide and magnesium oxide. These compounds may be used to adjust the pH of the finished product, but provide an additional soluble mineral nutrient that is in bioavailable form.

The food product may be further modified to remove undesirable minerals therefrom, such as sulfur and iron, by various techniques, including for example, removal by ion exchange. Passing the product through an ion exchange column containing, for example, weak anionic resins, such as Amberlite 22, Amberlite 51 and Rohm and Haas Amberlite FPA51, the mineral or “ash” content of the product can be decreased to desired levels, for example, to an amount of about 10% or less by weight. In addition, the iron content of raw corn distillers solubles may typically range from 100 to 140 ppm of iron on a dry weight basis. Treatment of the solubles by ion exchange (using a column containing a resin such as Amberlite FPA51) may be used to reduce the iron content of the food product to more desirable levels, for example, to a level less than about 80 ppm, preferably to a level less than about 50 ppm, and more preferably to a level of from 40 ppm to an undetectable level, such as 20 ppm to undetectable by weight.

The food product may be further augmented or enhanced by the addition of solids thereto. The enzyme-treated soluble fraction generally has low viscosity since the enzymatic activity has a thinning effect. Thus, additional solids may be added to the food product to result in a desired consistency. In one embodiment, for example, additional raw material may be added to the soluble by-product fraction prior to treatment according to the present method. This is particularly applicable to raw materials that require processing similar to that conducted in the present method. The food product may also be concentrated, e.g. by evaporating liquid therefrom, in order to increase viscosity to a desired level.

In another aspect of the present invention, there is provided a novel food product resulting from the method of processing the soluble by-product fraction as described above. The food product comprises an enzyme-treated soluble by-product fraction of ethanol production in which fermentable sugar content is at least about 10% of the total carbohydrate content of the food product. A food product having a greater fermentable sugar content, for example, 20-30% or more of the total carbohydrate content of the product is also attainable by increasing the reaction time as described above.

A food product prepared as described above is preferably used as a supplement comprising up to about 50% of total dietary solids uptake, and may be up to about 40%, 30%, 20% or 10% of total dietary solids uptake.

In order to increase the constituent level of the food product in total dietary solids uptake, the soluble by-product fraction may undergo an alternate processing regimen that may be implemented on its own or as a pretreatment to the foregoing process. In this regimen, the soluble by-product fraction, preferably prior to concentration, for example, by evaporation, is treated by an enzyme digestion which may be followed or preceded by removal of undesirable components such as fatty acids, phytates, ash and high mineral contents. These components are undigestible by the carbohydrate-digesting enzymes. By removing these components, this alternate regimen may yield a food product that can be incorporated into total dietary solids uptake at a level of greater than 10-20%.

The enzyme digestion step of this alternate processing regimen is conducted using enzymes capable of digesting complex polysaccharides and may include one or more enzymes such as hemicellulase, pectinase, cellulase, alpHagalactosidase and xylonase. The conditions of this digestion are similar to those outlined above, including a pH of between about 4.2 and 4.8 and a temperature of between about 30-60° C. for a period of time up to about 180 minutes, and preferably for a period of time between about 20 and 150 minutes.

The enzyme digestion may be preceded or followed by a step to separate a fatty fraction (the top layer) of the digested material from the remaining components of the soluble by-product fraction including proteins, sugars and yeast materials, i.e. the protein-containing fraction (the bottom layers). The protein-containing fraction may be further separated to yield an intermediate layer containing a substantial portion of the proteins and sugars and a heavier layer containing the partially digested materials of yeast and insoluble proteins. This separation of the enzyme digested material into fractions may be accomplished by any acceptable means of separation, as one of skill in the art will appreciate, and is preferably accomplished by centrifugation. In one embodiment, a disc type centrifuge, for example an Alfa-Laval AFPX 207, configured to effect a three way separation may be employed to intermittently discharge the fatty fraction, and the intermediate and heavy layers of the protein-containing fraction. Such a device may rotate, for example, at a speed of 5000 to 8000 RPM and may be fed with feed material at a rate of 2 to 10 gallons per minute. In another embodiment, the soluble by-product fraction is heated to decrease the viscosity of the lipid and to augment the separation process of the fatty fraction from the protein-containing fraction.

The food product resulting from this alternate regimen, comprising the protein-containing fraction either completely or further separated to include only the intermediate fraction, desirably has a low fatty acid content of less than about 10% dry weight, preferably a dry weight fatty acid content of less than 5%, and more preferably, a dry weight fatty acid content of less than about 2%.

To enhance the utility of this low fatty acid-containing food product, it may be processed further to remove at least some of the minerals, such as iron, which are naturally present in fermentation by-products. Removal of minerals is conducted by separation techniques well-established in the art, for example, passage through a separation column such as an ion exchange column (as described above), by using filtration or membrane technology, or by using a combination of a separation column and membrane filtration.

The heavy yeast material-containing layer may be further treated with enzymes suitable to digest remaining yeast bodies and complex carbohydrates, such as, protease, mannanase and betagluconase enzymes. The conditions for this enzyme digestion are similar to the conditions set out above. The digested product, having a high mannose content may itself be used as a food additive, or it may be recombined with the intermediate layer for further processing, including removal of fatty acids and, optionally, minerals.

Embodiments of the invention are described by reference to the following specific examples which are not to be construed as limiting.

### EXAMPLE 1

11,500 grams of corn distillers solubles to which 1.15 grams each of BHA and BHT have been added are placed in a jacketed stainless steel container fitted with a cover to enable flooding the surface volume with nitrogen or carbon dioxide gas to prevent oxidation of the fats during processing. A high speed, high shear mixer is immersed in the CDS. The PH of the CDS is adjusted to PH 4.2 using 20 grams of NaOH dissolved in a 20% solution. The solution is mixed. An enzyme mixture consisting of cellulase, beta-glucanase, xylonase, mannanse, hemmicellulase, is added. These enzymes are provided by 4 grams Viscozyme, 2 grams Celluclast, 3 grams Shearzyme, 3 grams EDC Mannanase, 2 grams EDC Beta-glunanase. The enzymes are diluted in distilled water to 50 grams and added, while stirring, to the CDS. The heating jacket is activated and the high shear mixer is turned on. After 15 minutes an additional protease enzyme, trade named Flavourzyme, is added while stirring. After an additional 10 minutes the PH is further adjusted with 20 grams of NaOH dissolved in a 20% solution, added while stirring, to achieve a PH of 4.80. The reaction continues with heating until a temperature of 52 degrees C. is attained. Heating is suspended temporarily. After an additional 60 minutes the PH is once again adjusted using 125 grams of NaOH dissolved in a 20% solution to achieve a new PH of 5.90. The reaction is allowed to continue for 10 minutes whereupon then reacted CDS material is transferred to a storage tank.

### EXAMPLE 2

1,048.0 kilograms of corn distillers solubles are placed in a jacketed stainless steel container. A high speed, high shear mixer is immersed in the CDS. The heating jacket is activated and the high shear mixer is turned on. An enzyme mixture consisting of alpha galactosidase, cellulase, beta-glucanase, xylonase, mannanase, hemmicellulase, pectinase, and phytase is added. These enzymes are provided by 250 grams Viscozyme, 65 grams Celluclast, 72 grams Shearzyme, 12 grams EDC Mannanase, 15 grams Bio-Cat Beta-glucanase, 10 grams of Enzeco IIFG, 10 grams of Enzeco CEP and 10 gram of phytase. The enzymes are diluted in distilled water to 500 grams and added, while stirring, to the CDS.

The pH of the CDS solution is adjusted by passing the mixture through an ion exchange column containing 4 cubic feet of a weak anionic resin such as Rohm and Haas Amberlite FPA51. The solution is pumped at a rate of 3 gallons per minute to allow the resin to attach various minerals including a substantial portion of the iron as well as a portion of the acidity. This raises the pH of the solution from approximately 4.00 to approximately 5.00. The ion exchange resin is regenerated to release the captured undesirable components by circulating approximately 150 gallons of a 4% solution of sodium hydroxide through the column for 30 minutes. The resulting black colored solution is discarded and the resin column is flushed with clean water and is ready for additional treatment of CDS.

After 2 hours in the reactor, 80 grams of an additional protease enzyme (Flavourzyme) is added after being diluted with 500 grams of distilled water. After an additional 2 hours of incubating with enzyme, the pH of the CDS solution is further adjusted by once again passing the mixture through an ion exchange column containing 4 cubic feet of a weak anionic resin such as Rohm and Haas Amberlite FPA51. The solution is pumped at a rate of 3 gallons per minute to allow the resin to attach additional various minerals including iron as well as a portion of the remaining acidity. This raises the pH of the solution from approximately 5.00 to approximately 6.00 pH. The reaction continues in the reactor with heating until a temperature of 60 degrees ° C. is attained and maintained. The reaction is allowed to continue for 2 hours whereupon then reacted CDS material is cooled and transferred to a storage tank.

A product having a 10% fermentable sugar content, an iron content of 40 parts per million and a mineral content of 8% was produced.

### EXAMPLE 3

11,500 grams of corn distillers solubles to which 1.15 grams each of BHA and BHT have been added are placed in a jacketed stainless steel container fitted with a cover to enable flooding the surface volume with nitrogen or carbon dioxide gas to prevent oxidation of the fats during processing. A high speed, high shear mixer is immersed in the CDS. The pH of the CDS is adjusted to pH 4.2 using 20 grams of NaOH dissolved in a 20% solution. The solution is mixed. An enzyme mixture consisting of cellulase, beta-glucanase, xylonase, mannanse, hemmicellulase, is added. These enzymes are provided by 4 grams Viscozyme, 2 grams Celluclast, 3 grams Shearzyme, 3 grams EDC Mannanase, 2 grams EDC Beta-glunanase. The enzymes are diluted in distilled water to 50 grams and added, while stirring, to the CDS. The heating jacket is activated and the high shear mixer is turned on. After 15 minutes an additional protease enzyme, trade named Flavourzyme, is added while stirring. After an additional 10 minutes the PH is further adjusted with 20 grams of NaOH dissolved in a 20% solution, added while stirring, to achieve a pH of 4.80. The reaction continues with heating until a temperature of 52 degrees C. is attained. Heating is suspended temporarily. After an additional 15 minutes the PH is once again adjusted using 125 grams of NaOH dissolved in a 20% solution to achieve a new PH of 5.90. The reaction is allowed to continue for 60 minutes whereupon the mixture is cooled to 30 degrees C. and a ferment containing active yeasts is added to the CDS and mixed. A portion of the inoculated CDS is returned to the ferment storage tank to replace and replenish the feedstock. The reacted and inoculated CDS material is transferred to a storage tank fitted with pressure relief valves to eliminated evolving CO2. The product may be spray dried immediately or it may be allowed to continue fermentation to ensure substantial removal of complex carbohydrates. The product may be used as a liquid or it may be spray dried. Spray drying should be carried out at a low temperature to ensure the viability of the cultures and enzyme systems so that they may be available for use by the livestock as prebiotics and probiotics.

### EXAMPLE 4

11,500 grams of corn distillers solubles to which 1.15 grams each of BHA and BHT have been added are placed in a jacketed stainless steel container fitted with a cover to enable flooding the surface volume with nitrogen or carbon dioxide gas to prevent oxidation of the fats during processing. A high speed, high shear mixer is immersed in the CDS. The PH of the CDS is adjusted to PH 4.2 using 20 grams of NaOH dissolved in a 20% solution. The solution is mixed. An enzyme mixture consisting of cellulase, beta-glucanase, xylonase, mannanse, hemmicellulase, is added. These enzymes are provided by 4 grams Viscozyme, 2 grams Celluclast, 3 grams Shearzyme, 3 grams EDC Mannanase, 2 grams EDC Beta-glucanase. The enzymes are diluted in distilled water to 50 grams and added, while stirring, to the CDS. The heating jacket is activated and the high shear mixer is turned on. After 15 minutes an additional protease enzyme, trade named Flavourzyme, is added while stirring. After an additional 10 minutes the PH is further adjusted with 20 grams of NaOH dissolved in a 20% solution, added while stirring, to achieve a PH of 4.80. The reaction continues with heating until a temperature of 52 degrees C. is attained. Heating is suspended temporarily. After an additional 60 minutes the PH is once again adjusted using 125 grams of NaOH dissolved in a 20% solution to achieve a new PH of 5.90. The reaction is allowed to continue for 60 minutes whereupon a second treatment of cultures is carried out by the addition of selected bacterium designed to convert linoleic acid to conjugated linoleic acid (CLA). The bacteria added are: 1 gram each of lactobacillus casei, lactobacillus acidopHilus, lactobacillus rhamnosus, propionibacterium freudenreichii shermaneii. The reacted, cultured CDS material is transferred to a storage tank fitted with pressure relief valves to eliminated evolving CO2. Alternately the bacterial culture may be added before a yeast culture in which case the CDS is allowed to culture for a period of 24 hours prior to the optional addition of the yeast. The product may be spray dried immediately or it may be allowed to continue fermentation to ensure substantial removal of complex carbohydrates. The product may be used as a liquid or it may be spray dried. Spray drying should be carried out at a low temperature to ensure the viability of the cultures and enzyme systems so that they may be available for use by the livestock as prebiotics and probiotics

### EXAMPLE 5

11,500 grams of corn distillers solubles to which 1.15 grams each of BHA and BHT have been added are placed in a jacketed stainless steel container fitted with a cover to enable flooding the surface volume with nitrogen or carbon dioxide gas to prevent oxidation of the fats during processing. A high speed, high shear mixer is immersed in the CDS. The pH of the CDS is adjusted to pH 4.2 using 20 grams of NaOH dissolved in a 20% solution. The solution is mixed. An enzyme mixture consisting of cellulase, beta-glucanase, xylonase, mannanse, hemmicellulase, is added. These enzymes are provided by 4 grams Viscozyme, 2 grams Celluclast, 3 grams Shearzyme, 3 grams EDC Mannanase, 2 grams EDC Beta-glunanase. The enzymes are diluted in distilled water to 50 grams and added, while stirring, to the CDS. The heating jacket is activated and the high shear mixer is turned on. After 15 minutes an additional protease enzyme, trade named Flavourzyme, is added while stirring. After an additional 10 minutes the PH is further adjusted with 20 grams of NaOH dissolved in a 20% solution, added while stirring, to achieve a PH of 4.80. The reaction continues with heating until a temperature of 52 degrees C. is attained. Heating is suspended temporarily. After an additional 15 minutes the pH is once again adjusted using 30 grams of lime and 15 grams of magnesium oxide are added to the mixture and thoroughly mixed. 20 grams of NaOH dissolved in a 20% solution to achieve a new pH of 6.00. The reaction is allowed to continue for 60 minutes whereupon the product may be used as a liquid or it may be spray dried. Spray drying should be carried out at a low temperature to ensure the viability of the enzyme systems so that they may be available for use by the livestock as prebiotics and probiotics. The resulting product has an elevated content of calcium and magnesium.

### EXAMPLE 6

A primary enzymatic treatment of hemicellulase, pectinase, cellulase, available as a commercial preparation Viscozyme, alpHagalactosidase, xylonase, cellulase, beta gluconase and pHytase was added to thin stillage obtained from Exol Ethanol after adjustment of the pH to 4.6. The product was heated to 45° C. and held for 12 hours. The product was then pumped to a separator centrifuge where a three-way separation was effected. The first fraction containing substantially all of the dispersed fat comprising approximately 10%, by volume, of the total feed was stored for disposal as a fat material. The middle, liquid fraction containing the soluble proteins discharged continuously from the top of the centrifuge and representing approximately 75% of the total flow, was the main target flow and was stored in a tank for further processing. The heavy fraction, representing approximately 15% of the total flow, was intermittently discharged from the centrifuge. This heavy material was stored for further processing.

The middle fraction was passed through an ion exchange column containing anionic resins, Amberlite 22 and then through an ion exchange column containing Amberlite 51 resin. After de-ashing through the sequential ion exchange process, the material was passed through membrane filtration, having a molecular weight cut-off of approximately 5,000, to separate the protein material from the dissolved carbohydrates, peptides and remaining minerals. The carbohydrate and mineral flow was passed through a nano-filtration process to separate the undesirable minerals from the carbohydrates, smaller proteins and peptides.

In another variation the middle fraction by-passed the ion exchange step and was passed directly through membrane filtration, having a molecular weight cut-off of approximately 5,000, to separate the protein material from the dissolved carbohydrates, peptides and minerals. The carbohydrate and mineral flow was passed through a nano-filtration process having a molecular weight cut-off of approximately 1,000 to separate the undesirable minerals from the carbohydrates, smaller proteins and peptides.

The protein flow retained from the first membrane separation was treated with a protease such as Flavourzyme, to effect a change of flavor and increase the digestibility of the proteins, was then sent to a Contherm scraped surface evaporator for concentration and was then spray dried.

In another variation this protein rich flow was stored under refrigerated conditions and used directly in liquid feeding systems as a protein supplement.

In another variation the concentrated carbohydrates and peptides from the nano-filtration process were recombined with the main concentrated protein flow prior to evaporation and spray drying.

The resulting products were characterized as having a fermentable sugar content of 10%, a solids content of about 28% of which 22% is protein, 18% is fat and in the case of the fat-reduced product, 8% is fat.

### EXAMPLE 7

6 bob calves of the age of two days were started on a liquid feeding regimen of 12.5% total solids including a mixture of standard calf milk replacer and the food product prepared as per Example 1. The proportion of food product in the feed being given to the calves was gradually increased until it accounted for 40% of the total solids over the 20-week feeding trial. Palatability and digestibility were acceptable; however, rates of gain were lower than the rates of gain in the control group. There was a 16% reduction in food cost using the food product.

### EXAMPLE 8

54 calves of the age of 3 weeks were started on a liquid feeding regimen of 12.5% total solids including a mixture of standard calf milk replacer and the food product prepared as per Example 1. The solids contributed by the food product were maintained to account for approximately 10% of the total solids over the 20 week feeding trial. Palatability and digestibility were acceptable and rates of gain were comparable to the control group with a reduction of feed costs.

### EXAMPLE 9

54 calves of the age of 3 weeks are started on a liquid feeding regimen of 12.5% total solids including a mixture of standard calf milk replacer and the food product prepared as set out in Example 6 representing the soluble, de-mineralized, lower fat, liquid, protein fraction. The solids contributed by the food product are gradually increased until they account for 40% of the total solids over the 20-week feeding trial. Palatability and digestibility are acceptable and rates of gain are comparable to the control group with a significant reduction in feed costs.

### REFERENCES

1 The Ethanol Industry Brief History, Plant Listing, Capacities
2 Distillers Dried Grains and their Impact on Corn, Soymeal, and Livestock Markets. Steve Markham, Commodity Specialists. Company, Agricultural Outlook Forum 2005
3 Nutritional Demand Drives Whey and Lactose Sales, Decision News Media, Nov. 22, 2005
4 Analysis of Various Raw Material and Components
5 Effects of Mannan Oligosaccharides or Antibiotics n Neonatal Diets on Health and Growth of Dairy Calves, A. J. Heinrichs, Department of Dairy and Animal Science, Penn State U, J. Dairy Sci. 86:4064-4069
6 W. J. Lee, F. W. Sosulski, and S. Sokhansanj. 1991. Yield and Composition of Soluble and Insoluble Fractions from Corn and Wheat Stillages. Cereal Chem. 68(5):559-562
7 Neil Hohmann, and C. Matthew Rendleman. 1993. Emerging Technologies in Ethanol Production. USDA, Econ. Res. Ser., Ag. Info. Bulletin Number 663.
8 Economic Value of Fuel Alcohol By-Products, Ag. Econ. Staff, Paper 81-68, US2MIU68
9 Margot Anderson. 1993. Ethanol Production, Corn Gluten Feed, and EC Trade. USDA, Econ. Res. Ser., Ag. Info. Bulletin Number 677.
10 Distillers Feeds, Distillers Feed Research Council, SF99D5D57
11 Effect of Corn Oil on Thin Stillage Evaporators, V. Singh, 1999, Cereal Chem 76(6):846-849
12 Dawley, Larry, U.S. Pat. No. 6,962,722, Nov. 8, 2005, High Protein Corn Product Production and Use
13 Protein-Rich Residue from Corn Alcohol Distillation: Fractionation and Characterization. V. V. Wu, K. R. Sexson, and J. S. Wall. Cereal Chem 58:343-347, American Association of Cereal Chemists, Inc.
14 Vijay Singh, Robert A. Moreau, Landis W. Doner, Steven R. Eckhoff and Kevin B. Hicks. 1999. Recovery of Fiber in the Corn Dry-Grind Ethanol Process: A Feedstock for Valuable Co-products. Cereal Chem. 76(6):868-872
15 Y. Victor Wu, Jerry W. King and Kathleen Warner. 1994. Evaluation of Corn Gluten Meal with Supercritical Carbon Dioxide and Other Solvents: Flavour and Composition. Cereal Chem. 71(3):217-219
16 F. W. Sosulski, W. J. Lee and S. Sokahansanj. 1991. Wet Milling and Separation of Wheat Distillers' Grains with Solubles into Dietary Fiber and Protein Fractions. Cereal Chem. 68(6):562-565
17 M. P. Hojilla-Evangelista, L. A. Johnson, and D. J. Myers. 1992. Sequential Extraction Processing of Flaked Whole Corn: Alternative Corn Fractionation for Ethanol Production. Cereal Chem. 69(6):643-647
18 Y. Victor Wu. 1988. Recovery of Stillage Soluble Solids from Corn and Dry-Milled Corn Fractions by High-Pressure Reverse Osmosis and Ultrafiltration. Cereal Chem. 65(4): 345-348
19 M. P. Hojilla-Evangelista, L. A. Johnson. 2003. Optimizing Extraction of Zein and Gutelin-Rich Fraction During Sequential Extraction Processing of Corn. Cereal Chem. 80(4):481-484.
20 The Use of Ethanol Distillery By-Products in Aquaculture. 1989. Illinois Dept. of Energy and Natural Resources.
21 John B. Braden, Frederick Leiner and Reo L. Wilhour. 1984. The Financial Aspects of Intermediate-Scale Joint Production of Fuel Ethanol and Livestock. Ag. Econ. Report, University of Illinois at Urbana-Champaign.
22 J. Lawton, Proteins of the Kernel, Corn Chemistry and Technology, 2^{nd} Edition
23 Faye M. Dong, Barbara A. Rasco, and Sahl S. Gazzaz. 1987. A Protein Quality Assessment of Wheat and Corn Distillers' Dried Grains with Solubles. Cereal Chem 64(4):327-332.
24 Charles Boyer, Carbohydrates of the Kernel, Corn Chemistry and Technology, 2^{nd} Edition
25 Weldon Maisch, Fermentation Processes and Products, Corn Chemistry and Technology, 2^{nd} Edition
26 Ethanol By-products for Beef and Dairy Cattle—Perception vs Reality, Rick Stock, Cargill, 2005 Pacific Northwest Animal Nutrition Conference, Boise, Id.
27 Vijay Singh, Pretreatment of Wet-milled Corn Fiber to Improve Recovery of Corn Fiber Oil and PHytosterols, Cereal Chem., 80(2):118-122, 2003
28 Method of Purifying Distillers solubles and use of purified matter, U.S. Pat. No. 4,278,699, Yoshizawa; Kiyoshi, 1981
29 Preservation and Feeding of Wet Distilers Grains to Dairy Cattle, Alvaro Garcia,
30 W. M. Seymour, Effects of Colostrum Substitute and of Dietary Brewers Yeast on the Health and Performance of Dairy Calves, J. Dairy Science, 1994
31 R. Blank, Effect of Fumaric Acid and Dietary Buffering Capacity on Ileal and Fecal Amino Acid Digestibilities in Early-Weaned Pigs, J. Anim. Sci. 1999. 77:2974-2984.
32 Concentrated Acid Technology, Arkenol Inc.
33 Blanche D. E. Gaillard, The digestion of yeast cell wall polysaccharides in veal calves, Br. J. Nutr. 1976, 36, 471
34 V. J. Williamson, Milk-substitute diet composition and abomasal secretion in the calf, Br. J. Nutr. 1976, 36, 317
35 Use of Distillers' Grain Solubles in Calf Starters, Kentucky Agricultural Experiment Station, University of Kentucky, Lexington, Bulletin 623, March 1955, C. A. Lassiter, D. M. Seath, R. F. Elliott, G. M. Bastin
36 Anja Theisinger, B. Granacher, K. S. Rech and E. Scharrer. 2002. Nucleosides are Efficiently Absorbed Across the Intestinal Brush Border Membrane in Veal Calves. J. Dairy Science. 85:2308-2314
37 Making Acidic Milk with Formic Acid for Ad Libitum Feeding to Calves; Neil Anderson—Veterinary Scientist/OMAF
38 D. D. Loy, Nutritional Properties and Feeding Value of Corn and Its By-products, Corn Chemistry and Technology, 2^{nd} Edition
39 J. M. Besle, Digestion of Alkane yeast carbohydrates by the preruminant calf, Reprod Nutr Dev. 1980: 20(5A): 1401
40 H. M. Timmerman, Health and growth of veal calves fed milk replacers with or without probiotics. J. Dairy Sc. 2005, 88:2154-2165
41 W. N. Arnold. Introduction. Yeast Cell Envelopes: Biochemistry, BiopHysics and Ultrastructure Volume I. Wilfred Niels Arnold, editor. CRC Press, Inc.
42 J. S. D. Bacon. Nature and Disposition of Polysaccharides Within the Cell Envelope. Yeast Cell Envelopes: Biochemistry, BiopHysics and Ultrastructure Volume I. Wilfred Niels Arnold, editor. CRC Press, Inc.
43 W. N. Arnold. Lipids. Yeast Cell Envelopes: Biochemistry, BiopHysics and Ultrastructure Volume I. Wilfred Niels Arnold, editor. CRC Press, Inc.
44 W. N. Arnold. Autolysis. Yeast Cell Envelopes: Biochemistry, BiopHysics and Ultrastructure Volume I. Wilfred Niels Arnold, editor. CRC Press, Inc.
45 Biosynthetic Mechanisms for Cell Envelope Polysaccharides Yeast Cell Envelopes: Biochemistry, BiopHysics and Ultrastructure Volume I. Wilfred Niels Arnold, editor. CRC Press, Inc.
46 R. G. Garrison and W. N. Arnold. Atlas of Cell MorpHology. Yeast Cell Envelopes: Biochemistry, BiopHysics and Ultrastructure Volume I. Wilfred Niels Arnold, editor. CRC Press, Inc.
47 Gunter Blodel. Proteins Have Intrinsic Signals that Govern Their Transport and Localization in the Cell. 1999 Nobel Prize in PHysiology or Medicine.
48 alpHa Galactosides from Lupin: a New Prebiotic for Application in Dairy Products.
49 Chemistry of Meat Processing, Food Science & Technology, Ohio State University, 2000
50 National Corn Growers and National Corn Refiners Current research
51 Maintenance of Intestinal Health is Key to Performance and Profit; Dr. Brian Hardy, NutriVision Inc; Animal Talk, Nottingham Nutrition International, July 2003
52 Yeast Cell Architecture and Function, Biochemie Material
53 F. M. LwMieux, Effect of Mannan Oligosaccharides on growth performance of weanling pigs, J. Anim. Sci. 2003. 81:2482-2487
54 Brian Hardy, Nutraceutical Concepts for Gut Health in Pigs, International Pig Topics, 2000, Vol 15. No. 8 23-25
55 Purina Mills, Calf Insure, Calf Milk Supplement, Product Bulletin, Irradiated Yeast
56 S. N. E. van Nierop, A. Cameron-Clarke, and B. C. Axell. 2004. Enzymatic Generation of Factors from Malt Responsible for Premature Yeast Flocculation. J. Am. Soc. Brew. Chem. 62(3):108-116.
57 H. B. Dunford, How do enzymes work, J. Biol. Inorg. Chem. 2001. October; 6(8):819-822
58 What are Yeasts
59 Fermentation of 6-carbon sugars
60 Recombinant Zymomonas for pentose fermentation, U.S. Pat. No. 5,726,053, 1998, Picataggio, StepHen
61 Bruce Dien, Fermentation of Hexose and Pentose Sugar Mixtures to Lactic Acid by Recombinant Bacteria, Am. Inst. Chem. Eng, Nov. 21, 2003
62 Miscellaneous technical papers regarding conversion of linoleic acid to CLA
63 Method for preparing conjugated linoleic acid, U.S. Pat. No. 6,960,456, 2005, Laasko; Simo
64 V. Fellner, Steady state rates of linoleic acid biohydrogenation by ruminal bacteria in continuous culture, J. Dairy Sci. Vol 78, No. 8, 1995
65 Effects of cultures of lactobacillus acidopHilus and propionibacterium freudenreichii on feedlot performance, Oklahoma State University research document, 2004
66 Propionibacterium freudenreichii ssp shernanii, Laboratoire Genetique et Biologie Cellulaire
67 Auli Rainio, Production of conjugated linoleic acid by Propionibacterium freudenreichii ssp shermanii, Lait 82 (2002) 91-101
68 Jun Ogawa, Conjugated linoleic acid accumulation via 10-hydroxy-12-octadecaenoic acid during micraerobic transformation of linoleic acid by lactobacillus acidopHilus, Applied and Environmental Microbiology, March 2001, p1246-1252
69 Hans Stein, Methods to determine amino acid digestibilities in corn by-products, Proceeding: 66^{th} Minnesota Nutrition Conference, 2005
70 Jerry Shurson, Corn by-product diversity and feeding value to non-ruminants, Proceeding: 66^{th} Minnesota Nutrition Conference, 2005
71 Y. V. Wu, K. L. Payne-Wahl, and S. F. Vaughn. 2003. Analysis of Headspace Volatiles of Corn Gluten Meal. Cereal Chem. 80(5):567-569
72 Nicholas Parris, Leland Dickey, and James Craig. 1997. Quantitative Analysis of Corn Zein by Capilliary ElectropHoresis. Cereal Chem. 74(6):766-770.
73 Manual of Microscopic Analysis of Feeding Stuffs. The American Association of Feed Microscopists.
74 J. S. Wall, Y. V. Wu, W. F. Kwolek, G. N. Bookwalter, and K. Warner. 1984. Corn Distillers' Grains and Other By-Products of Alcohol Production in Blended Foods. I. Compositional and Nutritional Studies. Cereal Chem. 61(6):504-509.
75 Feeding Value of Ethanol Production By-products
76 Description of 5 and 6 carbon sugars.
77 D. H. Baker, PHytates in Feed Swine Odor Waste Management, Nutrition University of Illinois
78 Irvine Liener, Control of anti-nutritional and toxic factors in oilseeds and legumes, Chapter 22.
79 Fred Martz, Conjugated Linoleic Acid Content of Pasture Finished Beef and Implications for Human Diets, A Report of Results From a Grant Awarded to the University of Missouri, Columbia, Mo.
81. 81. P. M. Nielsen. Enzyme Technology for Production of Protein-Based Flavours. Novo Nordisk A/S, Denmark.
82 Wu, Z., 0. A. Ohajuuka. And D. L. Palmquist. 1991. Ruminal synthesis, bioydrogenation, and digestibility of fatty acids by dairy cows. J. Dairy Sci. 74:3025.
83 Wu, z., and D. L. Palmquist. 1991. Synthesis and biohydrogenation of fatty acids by ruminal microorganismsin vitro. J. Dairy Sci. 74:3035.
84 Takanobu Higashiyama, Pure Appl. Chem., Vol. 74, No. 7, pp. 1263-1269, 2002. Novel functions and applications of trehalose
85 Shiyuan Yu, Morris Wayman *, Sarad K. Parekh; Fermentation to ethanol of pentose-containing spent sulpHite liquor Biotechnology and Bioengineering Volume 29, Issue 9, Pages 1144-1150, 2004

We claim:

1. A method of producing a food product from the soluble by-product fraction of ethanol production comprising the step of incubating the soluble by-product fraction with an enzyme mixture suitable to digest complex polysaccharides to yield a food product comprising a fermentable sugar content of at least about 10% of the total carbohydrate content of the food product.

2. A method as defined in claim 1, wherein, as a first step, the soluble by-product fraction is treated with at least one anti-oxidant.

3. A method as defined in claim 1, wherein the incubation is conducted under anaerobic conditions.

4. A method as defined in claim 1, including the additional step of incubating the enzyme digested by-product fraction with at least one protease under suitable conditions.

5. A method as defined in claim 1, including the additional step of digesting pentoses and hexoses.

6. A method as defined in claim 1, including the additional step of converting LA to CLA.

7. A method as defined in claim 1 including the additional step of removing at least a portion of the fatty acids either before or after the enzyme digestion to render a food product having a fatty acid content of less than about 10% by dry weight.

8. A method as defined in claim 1, including the additional step of removing at least a portion of the minerals in the enzyme-digested material.

9. A method as defined in claim 8, wherein ion exchange is used to reduce the iron content of the enzyme-digested material.

10. A food product comprising an enzyme-treated soluble by-product fraction of ethanol production in which fermentable sugar content is at least about 10% of the total carbohydrate content of the food product.

11. A food product comprising an enzyme-treated soluble by-product fraction of ethanol production in which the fatty acid content is less than about 10% by dry weight.

12. A food product as defined in claim 10, wherein the iron content is no more than about 80 ppm.

13. A food product as defined in claim 11, wherein the iron content is no more than about 80 ppm.

14. A food product as defined in claim 12, wherein the iron content is no more than about 40 ppm.

15. A food product as defined in claim 13, wherein the iron content is no more than about 40 ppm.

16. A method of producing a food product from the soluble by-product fraction of ethanol production comprising the steps of:
1) incubating the soluble by-product fraction with an enzyme mixture capable of digesting complex polysaccharides; and
2) removing at least a portion of the fatty acids from the enzyme digested material to render a food product having a fatty acid content of less than about 10% by dry weight.

17. A method as defined in claim 16, wherein the fatty acids are separated from the enzyme mixture by centrifugation.

18. A method as defined in claim 16, including the additional step of removing at least a portion of the minerals in the enzyme-digested material.

19. A food product as defined in claim 10, comprising a mineral content of no more than about 10% by weight of the product.

20. A food product as defined in claim 11, comprising a mineral content of no more than about 10% by weight of the product.
